(19) United States
(12) Patent Application Publication
(10) Pub. No.: US 2006/0184455 A1
(43) Pub. Date: Aug. 17, 2006

(54) System and method for privacy management

(76) Inventors: Steven P. Meyer, Richmond Hill (CA); Terrance Callahan, Shelburne (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(21) Appl. No.: 11/350,748

(22) Filed: Feb. 10, 2006

Related U.S. Application Data
(60) Provisional application No. 60/651,641, filed on Feb. 11, 2005.

(51) Int. Cl. G06Q 99/00; H04L 9/00

(52) U.S. Cl. 705/67

(57) ABSTRACT

There is disclosed a system and method for managing the privacy of a patient's PHI within a medical/healthcare domain (e.g. within a healthcare institution or organization). More generally, listing of a caregiver or assistant in a patient's circle-of-care is managed by a circle-of-care manager that tracks the names and any aliases for any caregivers/assistants, as well as the name and any aliases of the patient, throughout the medical/healthcare domain. Using a set of hierarchical rules determining access restrictions, the circle-of-care list is updated by the circle-of-care manager to reflect any changes in membership. Within the circle-of-care list, multi-level permissions and restrictions may be assigned to each caregiver/assistant, depending on the level of access required. Permissions and/or restrictions may be time-limited to expire automatically.

### CROSS-REFERENCE TO RELATED PATENT APPLICATIONS

This patent application claims the benefit of U.S. Provisional Application No. 60/651,641 entitled System and Method for Privacy Management, filed on Feb. 11, 2005.

### BACKGROUND

The present invention generally relates to a system and method for managing privacy, particularly in the context of health information.

There has been an increasing interest in, and need for, safeguarding patients' “protected health information” (PHI) since the introduction of health information privacy legislation in various jurisdictions. In the U.S., the federal legislation is known as the Health Insurance Portability and Accountability Act (HIPAA). In Ontario, Canada, the corresponding provincial legislation is the Personal Health Information Protection Act (PHIPA). Generally speaking, the intent of the health information privacy legislation is to allow properly authorized caregivers and healthcare professionals, i.e. those within the so-called “circle-of-care”, to have timely access to patients' PHI, computerized or otherwise, while at the same time restricting access to individuals not properly authorized or entitled to it.

By definition, members of a patient's circle-of-care need access to that patient's PHI for the purpose of treating the patient and managing his or her care. Dissemination of such patient information within the circle-of-care is therefore deemed not to be disclosure of PHI, whereas disclosure of the PHI outside of the circle-of-care may have serious legal and ethical ramifications. It is therefore of great importance to a healthcare organization to be able to correctly determine the membership for each patient's circle-of-care.

One of the challenges of correctly determining membership is that, over time, the list of authorized caregivers and healthcare professionals within the so-called “circle-of-care” may change. Various considerations may also apply in determining who should be authorized. Also, certain caregivers or healthcare professionals may require only partial access to some PHI, while not requiring access to other PHI. Thus, the solution to the problem of creating and maintaining a membership list for a patient's circle-of-care is not straightforward.

One proposal for a possible solution is described in passing in a U.S. patent application filed by Seliger et al. (now issued as U.S. Pat. No. 6,941,313). More specifically, Seliger et al. propose using the Clinical Context Object Workgroup (CCOW) Context Manager as a basis for implementing access control decisions. [See HL7 Context Management “CCOW” Standard: Technology- and Subject-Independent Component Architecture, Version 1.4, as published by Health Level Seven, Inc.]

In Seliger et al., there is a proposal to control access to PHI using some simple rule-based logic based on the CCOW Context Manager. Seliger et al. describe, for example, how the CCOW Context Manger may be used with auditing, and also how it may be used to implement selective blocking of context changes or control data access based on a rule set or lookup table. However, Seliger et al. make no attempt to further define these rule sets, or to describe how interaction with the rule set may be achieved.

As healthcare institutions and organizations have grown in size, they have also grown in technological complexity. In larger institutions and organizations, it is not unusual that a patient's PHI is scattered across a number of different systems, collectively forming a health information system interconnected over a computer network. The result is that a user on one of the systems may be known by a different username from the same user on another one of the systems. Likewise, a patient may be entered under multiple names or aliases on different systems. As well, each user may require, or be entitled to access, only a portion of a patient's PHI. This poses a technical challenge for managing an accurate list for a patient's circle-of-care.

What is needed is a system and method for privacy management that can deal with the complexities of patient/caregiver interactions as may be found in a large healthcare institution or organization.

### SUMMARY

The present invention provides a system and method for managing the privacy of a patient's PHI within a medical/healthcare domain (e.g. within a healthcare institution or organization). More generally, listing of a caregiver or assistant in a patient's circle-of-care is managed by a circle-of-care manager that tracks the names and any aliases for any caregivers/assistants, as well as the name and any aliases of the patient, throughout the medical/healthcare domain. Using a set of hierarchical and/or weighted rules determining access restrictions, the circle-of-care list is updated by the circle-of-care manager to reflect any changes in membership. Within the circle-of-care list, multi-level permissions and restrictions may be assigned to each caregiver/assistant, depending on the level of access required. Permissions and/or restrictions may be time-limited to expire automatically.

In an aspect of the invention, there is provided a computer-implemented method for managing access to a patient's protected health information (PHI) within a healthcare domain, comprising: (i) providing a user identity for each user; (ii) providing a patient identity for each patient; (iii) for each patient's patient identity, associating at least one user's user identity with the patient's circle-of-care; (iv) for each user request for access to the patient's PHI, determining access based on whether the user's user identity is associated with the patient's circle-of-care.

In an embodiment the method further comprises, for each user request for access, specifying a subset of the patient's PHI to which access is requested.

In another embodiment the method further comprises, for each user request for access, specifying the user's role and a reason for access to the patient's PHI.

In another embodiment the method further comprises, for each user request for access, specifying a timeframe for access to the patient's PHI.

In yet another embodiment the method further comprises, in response to each user request for access, processing at least one applicable rule within a rules engine and outputting an access ruling which is one of a full permission, a partial permission, and a restriction.

In another embodiment the method further comprises processing at least one applicable rule based on laws and regulations governing the healthcare domain jurisdiction.

In another embodiment the method further comprises processing at least one applicable rule based on organizational policies and procedures for the healthcare domain.

In a further embodiment the method further comprises processing at least one applicable rule based on clinical context object workgroup (CCOW) standards.

In another embodiment the method further comprises outputting an explanation for the access ruling based on the at least one applicable rule applied.

In another embodiment the method further comprises storing the patient's PHI in a relational database and associating with the patient's PHI at least one level of user clearance required to access the patient's PHI.

In another embodiment the method further comprises associating with each level of user clearance a list of permissions, the list of permissions including at least one of access, update, create, delete and disclose.

In another embodiment the method further comprises storing the patient's PHI in a relational database and associating with a subset of the patient's PHI a level of user clearance required to access the subset of the patient's PHI.

In still another embodiment the method further comprises operating at least one circle-of-care node, each circle-of-care node including a circle-of-care list for associating at least one user's user identity with the patient's circle-of-care.

In another embodiment the method further comprises searching each circle-of-care list of the least one other circle-of-care node to identify any multiple aliases for a user identity, and upon detection of multiple aliases for a user identity, associating the multiple aliases with a patient's circle-of-care.

In another embodiment the method further comprises operating the at least one circle-of-care node as a web-based server, and permitting communications with each circle-of-care list from any user system within the healthcare domain.

In another aspect of the invention, there is provided a system for managing access to a patient's protected health information (PHI) within a healthcare domain, comprising: means for providing a user identity for each user; means for providing a patient identity for each patient; means for associating at least one user's user identity with the patient's circle-of-care for each patient's patient identity; means for determining, for each user request for access to the patient's PHI, access based on whether the user's user identity is associated with the patient's circle-of-care.

In an embodiment the system further comprises means for specifying, for each user request for access, a subset of the patient's PHI to which access is requested.

In another embodiment the system further comprises means for specifying, for each user request for access, the user's role and a reason for access to the patient's PHI.

In another embodiment the system further comprises means for specifying, for each user request for access, a timeframe for access to the patient's PHI.

In another embodiment the system further comprises means for processing, in response to each user request for access, at least one applicable rule within a rules engine; and means for outputting an access ruling which is one of a full permission, a partial permission, and a restriction.

In another embodiment the system further comprises means for processing at least one applicable rule based on laws and regulations governing the healthcare domain jurisdiction.

In yet another embodiment the system further comprises means for processing at least one applicable rule based on organizational policies and procedures for the healthcare domain.

In another embodiment the system further comprises means for processing at least one applicable rule based on clinical context object workgroup (CCOW) standards.

In another embodiment the system further comprises means for outputting an explanation for the access ruling based on the at least one applicable rule applied.

In another embodiment the system further comprises means for storing the patient's PHI in a relational database and associating with the patient's PHI at least one level of user clearance required to access the patient's PHI.

In another embodiment the system further comprises means for associating with each level of user clearance a list of permissions, the list of permissions including at least one of access, update, create, delete and disclose.

In another embodiment the system further comprises means for storing the patient's PHI in a relational database; and means for associating with a subset of the patient's PHI a level of user clearance required to access the subset of the patient's PHI.

In yet another embodiment the system further comprises means for operating at least one circle-of-care node, each circle-of-care node including a circle-of-care list for associating at least one user's user identity with the patient's circle-of-care.

In another embodiment the system further comprises means for searching each circle-of-care list of the least one other circle-of-care node to identify any multiple aliases for a user identity; and means for associating, upon detection of multiple aliases for a user identity, the multiple aliases with a patient's circle-of-care.

In still another embodiment the system further comprises means for operating the at least one circle-of-care node as a web-based server; and means for communicating with each circle-of-care list from any user system within the healthcare domain.

In another embodiment the system further comprises means for communicating comprises an extensible message format.

In still another embodiment the extensible message format is extensible markup language (XML).

In another embodiment the means for associating the at least one user's user identity with the patient's circle-of-care comprises a circle-of-care node having data storage components, the data storage components including: a directory database, the directory database including the user identity for each user; a relational database, the relational database including patients' PHI; a rules database, the rules database including applicable access rules; and a configuration database, the configuration database including information about the circle-of-care node and other circle-of-care nodes.

In yet another embodiment the means for associating the at least one user's user identity with the patient's circle-of-care comprises a circle-of-care node having computational components, the computational components including: a rules engine, the rules engine including at least one applicable rule based on legal requirements, organizational policies, patient restrictions and consents, the role of the user, and accumulated circle-of-care records; a reporting engine, the reporting engine configured to provide reports on queries received by the circle-of-care node; and an analysis engine, the analysis engine configured to analyze incoming messages to extract necessary information for associating a user identity to a patient's circle-of-care.

In still another embodiment the means for associating the at least one user's user identity with the patient's circle-of-care comprises a circle-of-care node having communication components, the communication components including: a security layer, the security layer configured to implement node authentication and encryption; a network server, the network server for supporting a network communication interface; a directory query, the directory query configured to query external user directories via the network communication interface, and a node query, the node query configured to query other circle-of-care nodes via the network communication interface.

The invention will become apparent from the following more particular descriptions of exemplary embodiments.

### BRIEF DESCRIPTION OF THE DRAWINGS

In the figures which illustrate exemplary embodiments of the invention:

FIG. 1 shows a schematic block diagram of a network facility that may provide an operating environment for practising the invention;

FIG. 2 shows a schematic block diagram of illustrative components of a circle-of-care node that may be found within the network facility of FIG. 1.

### GLOSSARY OF TERMS

HIPAA: Health Insurance Portability and Accountability Act of 1996 (U.S.).

PHIPA: Personal Health Information Protection Act, 2004 (Ontario, Canada).

Protected Health Information (PHI): In PHI, “protected” may sometimes be replaced by ‘“patient” or “private”, while “health” may sometimes be replaced by “healthcare”. According to HIPAA, PHI describes all identifiable health and health-related information about a patient that is created or received by a “health care provider, health plan, public health authority, employer, life insurer, school or university, or health care clearinghouse”: According to HIPAA, this information may not be disseminated to third parties without consent of the patient or used for anything other than the health-related benefit of the patient.

Circle-of-care: This is the identifiable group of caregivers and associated staff who provide healthcare services to a particular patient. These are the people who require access to the patient's medical information for the health-related benefit of the patient. HIPAA makes reference to this group as those involved in Treatment, Payment, and Organizational (TPO) activities.

Disclosure of PHI: This is the dissemination of PHI to recipients outside of the circle-of-care or for purposes other than the well-being of the patient. Authorized disclosures and legally obligated disclosures are permissible, while an unauthorized disclosure of PHI may constitute an offence.

Medical/Healthcare Domain: In the present discussion, a medical or healthcare “domain” is intended to represent the extent to which the circle-of-care is applied. For a clinic or hospital, the domain may be the facility, and may perhaps include outside physicians associated with the facility as well. For a networked group of hospitals and clinics, the domain may include all the hospitals and their associated healthcare facilities. In the case of a province or state-wide Electronic Health Record (EHR), the domain may well encompass the entire province or state, or even a country.

PHI subsets: There are many ways that PHI may be segmented. For example, they may be classified by medical categories such as symptoms, diagnoses or treatments. They may be classified by clinical areas, such as radiology, obstetrics, pharmacology etc. or they may be classified by time and/or location, such as a hospital stay or encounter.

User Roles: User roles are categories defined by the healthcare organization, based on user characteristics such as job functions (e.g. physician, nurse, clerk, network administrator, etc.), seniority, location (e.g. emergency, long-term care, admissions) and specializations.

### DETAILED DESCRIPTION

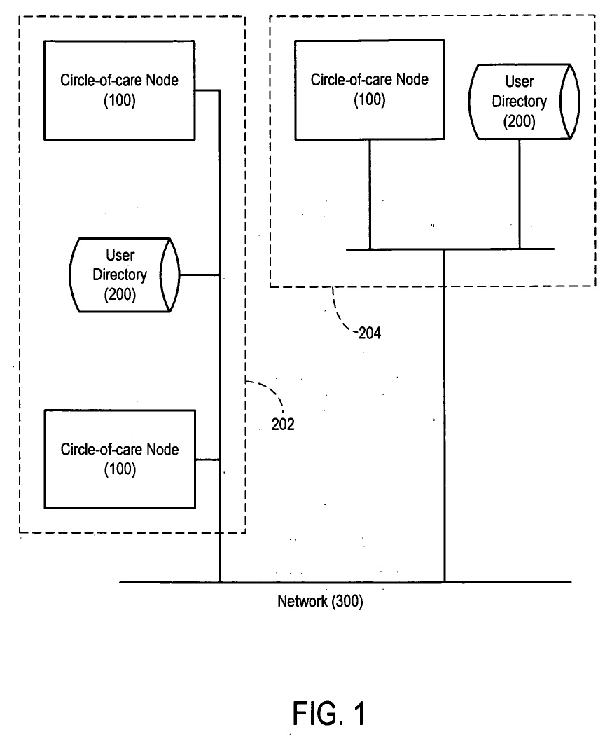

Referring to FIG. 1, there is shown a schematic block diagram of an illustrative network facility that may provide an operating environment for practising the invention. As shown, the network facility may comprise a number of circle-of-care nodes 100, and user directories 200. A plurality of circle of care nodes 100 and user directories 200 may form geographically distributed clusters 202, 204 interconnected by a network 300.

Circle-of care node 100 may be configured, for example, as a server running a healthcare information database application within a healthcare domain. User directory 200 may be configured to contain user information that may be accessed by a circle-of-care node 100, as will be explained in further detail below.

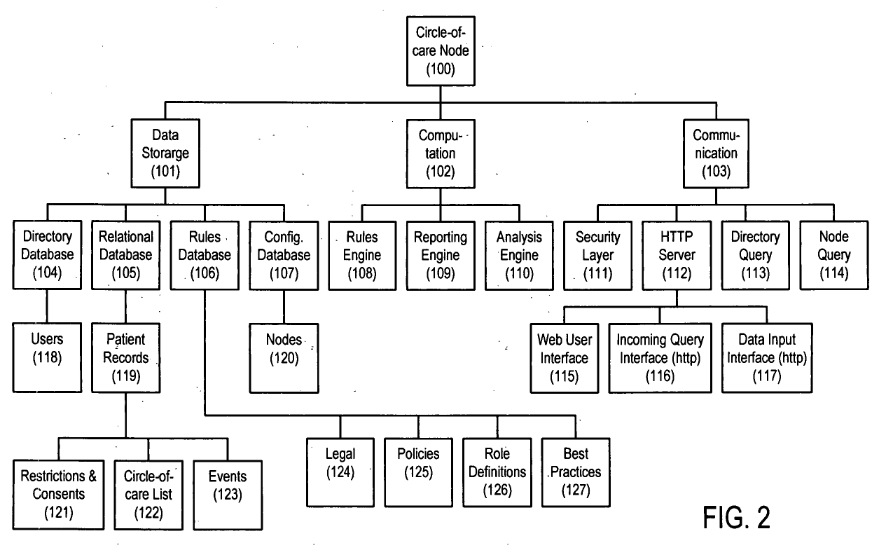

Referring now to FIG. 2, shown is an illustrative example of a circle-of-care node 100 comprising computer hardware and software. The computer hardware and software may provide support for various components, including data storage components 101, computational components 102, and network communication components 103.

The data storage components 101 may include, for example, a directory database 104, a relational database 105, a rules database 106, and configuration database 107. More generally, directory database 104 may be used for storing information about users of the computer systems in the network. Relational database 105 may be used for storing information about the patients, their PHI and the accumulated circle-of-care records. Rules database 106 may be used for storing the intelligence rules on how to manage PHI. Finally, a configuration database 107 may be used to store information on this and other nodes in the system, including node addresses, node capabilities and node authentication keys.

Computational components 102 may be made up of the following: a rules engine 108, a reporting engine 109, and an analysis engine 110. More generally, the rules engine may be, for example, an expert system that interprets the requests for access to PHI. The rules engine may use as input the organizational policies, legal requirements, patient restrictions and consents, the role of the user and the accumulated circle-of-care record to compute the access and permissions to PHI. The rules engine may also be used to determine when users are to be removed from the patient's circle-of-care record. The reporting engine 109 may provide reports to the administrator on the queries and updates received by the server. Finally, the analysis engine 110 may analyse the incoming messages and extract the necessary patient/user relationships in order to create the circle-of-care record for each patient.

The communication components 103 may comprise the following: a security layer 111, a HTTP server 112, a directory query 113, and a node query 114. More generally, security layer 111 may implement node authentication and encryption for network communication access using secure socket technology, or another technology. HTTP server 112 may implement a HTTP server to support both the web user interface and http-based process-to-process communication. Directory query 113 may be used to query the external user directories 200 in the network when the user information in the local directory is not available or has expired. Node query 114 may be used to query the other circle-of-care nodes in the network to maintain coherent data about patients on all the circle-of-care nodes.

HTTP server 112 may support a number of applications as follows: a web user interface 115, an incoming query interface 116, and a data input interface 117. More generally, web user interface 115 may be used for maintenance of the system and to provide a web-based functional interface whereby users can log in and create and maintain the various policies, requirements, restrictions, consents and roles used by the rules engine 108. Incoming query interface 116 may be configured to accept and respond to the automated network queries received from network client workstations and other circle-of-care nodes. Data input interface 117 may be configured to receive messages from a variety of detection sources (e.g. audit logs, network sniffers, application-embedded libraries) and intelligently constructs the circle-of-care record for the respective patients. The rules for doing this may be created by appropriate personnel at the healthcare domain and stored in the rules database 106. The way in which these rules are created in accordance with the present invention is explained in more detail, below.

It will be appreciated that the components of the circle-of-care node 100 described above are illustrative, and are not meant to limit the specific type of operating environment in which the invention may be practiced.

As noted, under various pieces of health information privacy legislation, only authorized caregivers or healthcare professionals within a patient's circle-of-care should be given access to a patient's PHI. In accordance with the present invention, this is facilitated by creating and maintaining a circle-of-care list defining for each patient which caregivers and assistants can access that patient's PHI at any given time. The circle-of-care list may be embodied, for example, on a data processing system server running application software suitably configured for the purpose. An illustrative example of such a server is shown as circle-of-care node 100 in FIG. 1. Such a circle-of-care list may be periodically updated, or continually updated on a real-time basis.

The circle-of-care list made available on the circle-of-care node 100 may then be checked each time an access to the PHI of a particular patient is initiated by a caregiver or assistant. At any point in time, a system being used by a caregiver and connected to network 300 may query a circle-of-care list on one of the circle-of-care nodes 100 to determine, and optionally to display, whether the caregiver is entitled to have access to a particular patient's PHI.

As noted, in larger healthcare domains such as a hospital, a caregiver or healthcare professional may be referred to by multiple aliases. In order to support a complete list of patient/caregiver interactions, the multiple aliases may be associated with a unique user identifier. Such a list of users and aliases may be stored, for example, in the directory database 104 of each circle-of-care node 100. Likewise, a patient known by multiple aliases may also be given a unique patient identifier. Patient information stored in the relational database 105 may be associated with the unique patient identifier. Thus, any one of a number of user aliases may be correctly matched to any one of a number of patient aliases.

For the purposes of providing layered access to subsets of patient PHI, each piece of PHI data, as stored on relational database 105 for example, may be associated with a required level of access clearance as determined according to rules by the circle-of-care manager. Therefore, a query may contain not just the names/aliases of the user and the patient, but also some description of the subsets of PHI for which access is desired. Thus, for example, a portion of PHI that uniquely identifies a patient may be associated with the highest level of access clearance as determined by the rules, while a portion of PHI that may not provide identifying information on its own may be associated with a lower level of access clearance as determined by the rules.

An important aspect of maintaining a useable list of caregivers and assistants is to facilitate inputs of data from a number of information sources. These information sources may range from customized interfaces that enable direct user input—for example a web page that an administrator can use to explicitly add or remove users from the circle-of-care—to indirect information sources, such as audit information where user and patient interactions are evident. For example, if a particular diagnostic image is sent to a radiologist for analysis, then that radiologist may automatically be added to the circle-of-care list of a patient. The radiologist's access may be limited, however, only to the PHI relating to the patient's current treatment.

The methods by which the information may reach a circle-of-care manager (e.g. as embodied in each circle-of-care node 100) are numerous. One such technique is to use an access audit trail generated by the various systems to provide information on the patient/user/PHI relationships. Many medical systems generate audit records for internal tracking, and these may be used to extract the required information, provided that the data format may be understood. Alternatively, if there is a common specification in place, as is the case for a centralized auditing system [See, for example, the IHE IT Infrastructure Technical Framework Supplement 2004-2005, Audit Trail and Node Authentication Profile (ATNA), Trial Implementation Version, Aug. 15, 2004], then the audit messages themselves may contain the information needed by the circle-of-care manager. As noted above, data input interface 117 may be configured to receive messages from a variety of information sources so that the circle-of-care manager may construct a circle-of-care record for each patient.

As an illustration, an audit log for the above example of a diagnostic image being sent to a radiologist may contain the following:
ID of the patient
ID of the source (Application Entity Title)
ID of the destination (Application Entity Title)
ID of the sender (user)
date/time
references to the data being sent
   From the destination field in the above audit log, and user-authentication audit messages, it is possible for the circle-of-care manager to deduce the name of the recipient (i.e. radiologist) so that the radiologist can be included in the circle-of-care listing.

Since this data may be received in real time by data input interface 117, the audit messages may be scanned for circle-of-care information at the same time, and passed on to the circle-of-care manager for processing.

While real-time data may be used, it is not mandatory. For example, it is quite feasible to scan historical audit logs and databases periodically to extract the information. This may also be necessary, for example, when first setting up a circle-of-care list in a new healthcare domain.

Another method of keeping the circle-of-care list up-to-date is for the circle-of-care manager to mine data sources used in various healthcare activities, including, but not limited to, the various archives and patient databases used in healthcare systems, e-mail servers, work list servers and the file systems of computers in the medical environment.

In order to effectively maintain a circle-of-care list, it will be appreciated that the general rules provided by the healthcare facility, the prevailing legislation, common medical and business practise, the user role and the patient's own requests must all be considered. More generally, a rule-based system should be responsive to the following:

Laws and Regulations: Access to patient information is generally restricted by legislation and regulation in many countries of the world. Many restrictions, however, vary from location to location. As well, there are special restrictions and permissions provided for special cases, such as national security, law enforcement, disease control and certain types of medical conditions. For example, certain VIPs, such as ministers of state, are accorded more privacy than would be required for the average citizen. In another example, patients with highly dangerous, contagious diseases must be disclosed to the necessary authorities.

Organizational Policies and Procedures: Organizations must create policies and procedures regarding the handling of healthcare information. These form the general rules by which members of the organization may or may not access and change patient information. These rules are important because they allow free-flow delivery of health care. Without them the administration overhead in creating PHI access lists would be immense. For example, the organization may stipulate that all qualified radiologists in the radiology department may have access to all diagnostic images of all patients, going back 12 months. However, the organization may also stipulate that patients in the facility who are also employed by the facility will not have their PHI viewed by anyone not explicitly authorized. This latter rule would then take precedence over the previous rule. These rules may be refined over time, until the healthcare organization strikes the right balance between patient privacy and smooth delivery of healthcare.

User Role: The role of the user is critical to the application of fine-grain access control. For example, a role-based rule may specify that only medical personnel can create or modify clinical information, while administration personnel may only change demographic patient information.

Patient's Consent and Restrictions: Patients may ask for specific restrictions to be applied to their health record, and these must be honoured by the system. For example, a patient may ask that his location in the hospital not be divulged. This restriction must therefore be presented to anyone wishing to see the patient's status. Patients may also provide explicit consents for certain users to have access to particular parts of their healthcare record. For example, a patient may allow an outside doctor to inspect her ultrasound images for research or teaching purposes, which is not normally permitted.

Patient Status and Condition: Certain rules may apply for access to PHI in special circumstances. In cases of medical emergency or potential danger medical personnel may need access to information not otherwise permitted. The circumstances or reason for the access will therefore also be considered in providing access to PHI.

Common Rules: Perhaps the most general rule to apply is one that allows caregivers who are treating the patient and generating and updating the personal health information to have access to the PHI. These names may be added to the circle-of-care list. This and other rules may be generally applied, unless superseded by more specific rules. For example, if a caregiver has previously created a medical document on a particular patient, then that caregiver should continue to be able to access and update that document, even if the caregiver is no longer active in the treatment of the patient. Certain information may also be available to non-medical system users who are involved in the management or billing procedures of the facility. There may even be some personal health information that can be displayed in a limited public fashion, such as a directory of patients in a ward.

Therefore, using a rules engine, the circle-of-care manager may apply any or all of the above rules, in an appropriate order, to come up with the resulting access permissions. For this purpose, each rule may be assigned a weight, or a relative priority in a hierarchy, such that where multiple rules may apply, the rules engine processes the rules in correct order.

By way of example, applying a set of hierarchical or weighted rules programmed into the rules engine, if a patient completes a course of treatment and is discharged from the hospital, then that patient's medical information may become restricted to the hospital medical staff as of discharge.

As another example, again applying a set of hierarchical or weighted rules programmed into the rules engine, if a patient comes into the emergency room, then whoever is on duty at the time may initially require full access to the relevant sections of the patient's record. However, if the patient is subsequently admitted to a ward, then only the doctor or other caregivers who actually administered to the patient may require access to the patient's record, and then only to the information relating to the emergency room encounter.

In yet another example; applying a set of hierarchical or weighted rules programmed into the rules engine, if a patient is also a worker employed by a healthcare domain, the patient may have a right to permit or restrict access to some or all of his/her PHI by other workers. Hence the circle-of-care may be a dynamically changing list of members.

Referring back to FIG. 1, the invention may be practiced across a computer network 300 in which external processes may be allowed to authenticate themselves and to query a circle-of-care manager (e.g. as embodied in one of the circle-of-care nodes 100) for access permissions and restrictions to PHI. These processes may be individual programs running on the network, such as an image viewer application, or they may be part of a mapping agent, such as within a CCOW Context Management workstation. In the latter case, the processes may query the circle-of-care manager to assess the level of access allowed to applications on the workstation.

The processes may also exist within a web server application, for example, which will query a circle-of-care manager on behalf of the clinical applications running on the web server. Furthermore, the processes may also exist within a web portal application, which will query the circle-of-care manager on behalf of the clinical applications hosted on the web portal. In this case, the query message may be in a structured XML format to provide flexibility and extensibility. A set of such messages may be used, from a simple lookup query involving only one piece of patient information and eliciting a yes/no response, to a compound query where multiple pieces of PHI are queried and the responses will contain permissions for use of PHI, such as ACCESS, UPDATE, CREATE, DELETE and DISCLOSE, on a piece-by-piece basis. A dictionary may be created, so that the query and response parameters can be assigned standard values. This will facilitate decoding and interpretation of these messages.

For example, the dictionary may be a table of enumerated values and meanings used to provide unambiguous interpretation of the messages. Organizations may choose which dictionaries they use. However, dictionary values must be unique within the context of the dictionary. The following example provides a suggestion of how a dictionary may be constructed:

Default Dictionary

| Unique Value | Class | Description |
|---|---|---|
| 1 | Type | Simple-lookup |
| 2 | Type | Multiple-lookup |
| | . . . | |
| 18 | Reason | Consultation |
| 19 | Reason | Follow-up treatment |
| | . . . | |
| 31 | Item | Encounter-by-date |
| 32 | Item | All encounters |
| 33 | Item | Report |
| | . . . | |
| 102 | Role | Admissions Clerk |
| 108 | Role | Doctor |
| | . . . | |
| 1000 | Permission | Restricted |
| 1001 | Permission | ACCESS only |
| 1002 | Permission | CREATE only |
| 1003 | Permission | CREATE and ACCESS |
| | . . . | |

By way of example, the following is one possible XML implementation of a query message using some of the values listed in the above dictionary. In this case a doctor wants to view the patient information from a previous consultation (i.e. encounter):

```
<!- Sample Query Message ->
<CircleOfCareQuery>
    <ServerQuery
        typeDisplay=”Simple-lookup”
        typeSystem=”default”
        QueryDateTime=”2005-01-31T14:00:00”
        QueryUID=”432X45AA9254”>1</ServerQuery>
    <QueryReason
        reasonDisplay=”Follow-up treatment”
        reasonSystem=”default”>19</QueryReason>
    <SourceNode>node1234</SourceNode>
    <ParticipantUser>ssmith@centralhospital  </Patient>
    <PHI Description>
        <item
            itemID=”31”
            itemDisplay=”Encounter-by-date”
            itemSystem=”default”>2004-09-1</item>
    </PHI Description>
</CircleOfCareQuery>
```

The following is an example of a response to the above query, also in XML format. In this example assume that there is a rule that causes the circle-of-care manager to return the most general class of restriction for the subset specified. i.e. the user does not have to request this information for each encounter lookup if the same restriction applies to all:

```
<!- Sample Response->
<CircleOfCareResponse>
    <ServerResponse
        permissionDisplay=”ACCESS only”
        permissionSystem=”default”
        ResponseDateTime=”2005-01-31T14:00:11”
        ValidityDateTime=”2005-02-1T00:00:00”
        QueryUID=”432X45AA92546FE3”
        ResponseUID=”54BF53646727199B”>1001</ServerResponse>
    <ServerNode>node1234</ServerNode>
    <ParticipantUser
        domain=”centralhospital”
        roleID=”108”
        roleDescription=”doctor”
        roleSystem=”default”>ssmith</ParticipantUser>
    <Patient
        domain=”centralhospital”>1234567890</Patient>
    <PHI Description>
        <item
            itemID=”32”
            itemDisplay=”all encounters”
            itemSystem=”default”></item>
    </PHI Description>
</CircleOfCareQuery>
```

In the above illustrative query and response, it can be seen that the doctor has requested to see certain patient information relating to a previous encounter with the patient. The circle-of-care manager has checked that the doctor is part of the patient's circle-of-care and has approved access to read this information. In addition, this access has been extended to the wider scope of information permitted to the doctor for the remainder of the day, so that the system need not query again if the doctor needs to see some more patient information. The validity time stamp is important, because it permits the doctor's computer system to dispose of the access approvals when they no longer apply, with the minimum of overhead. Also important is the unique query and response unique identifiers (UIDs). These allow the system to record PHI access events for PHI access that can be verified with the circle-of-care manager and later audited.

While the use of this illustrative XML format may be currently advantageous because of implementation considerations, it is contemplated that there may be variations and enhancements to this messaging scheme that change the format without altering the underlying communication intent.

In accordance with another aspect of the invention, a database facility may be provided (e.g. relational database 105) which not only contains a current circle-of-care list, but also historical data about past circle-of-care lists. A suitable data retention policy may be implemented to ensure that it is possible to determine a circle-of-care list for a patient during a specific time period in the past. This may facilitate, for example, auditing functions to ensure that appropriate privacy protocols are being followed within the healthcare domain.

For small healthcare domains, a single database with a circle-of-care manager may be used to implement this functionality. For organizations comprising numerous computer network clusters, a system of geographically distributed circle-of-care management nodes may be used (see FIG. 1, for example). These distributed circle-of-care nodes 100 may communicate with each other so that they may form a redundant information network, capable of making local decisions when sufficient information is present, but also able to seek out and find necessary user information from other nodes when the locally stored information is not adequate. Hence, even though a particular circle-of-care manager may be located within a particular cluster, it may be capable of obtaining information network-wide.

In accordance with another aspect of the invention, a reconciliation mechanism may be used so that users who are defined in multiple places can be mapped to each other. In the example shown in FIG. 1, the circle-of-care nodes 100 may dynamically cache directories locally so that directory queries are efficient, and the locally cached directories may be a compiled subset of the system directories, such that the user aliases are represented for each user.

While various illustrative embodiments of the invention have been described above, it will be appreciated by those skilled in the art that variations and modifications may be made. Thus, the scope of invention is defined by the following claims.

What is claimed is:

1. A computer-implemented method for managing access to a patient's protected health information (PHI) within a healthcare domain, comprising:
(i) providing a user identity for each user;
(ii) providing a patient identity for each patient;
(iii) for each patient's patient identity, associating at least one user's user identity with the patient's circle-of-care;
(iv) for each user request for access to the patient's PHI, determining access based on whether the user's user identity is associated with the patient's circle-of-care.

2. The method of claim 1 further comprising, for each user request for access, specifying a subset of the patient's PHI to which access is requested.

3. The method of claim 1 further comprising, for each user request for access, specifying the user's role and a reason for access to the patient's PHI.

4. The method of claim 1 further comprising, for each user request for access, specifying a timeframe for access to the patient's PHI.

5. The method of claim 1 further comprising, in response to each user request for access, processing at least one applicable rule within a rules engine and outputting an access ruling which is one of a full permission, a partial permission, and a restriction.

6. The method of claim 5, further comprising processing at least one applicable rule based on laws and regulations governing the healthcare domain jurisdiction.

7. The method of claim 6, further comprising processing at least one applicable rule based on organizational policies and procedures for the healthcare domain.

8. The method of claim 7, further comprising processing at least one applicable rule based on clinical context object workgroup (CCOW) standards.

9. The method of claim 5 further comprising outputting an explanation for the access ruling based on the at least one applicable rule applied.

10. The method of claim 1 further comprising storing the patient's PHI in a relational database and associating with the patient's PHI at least one level of user clearance required to access the patient's PHI.

11. The method of claim 10 further comprising associating with each level of user clearance a list of permissions, the list of permissions including at least one of access, update, create, delete and disclose.

12. The method of claim 1 further comprising storing the patient's PHI in a relational database and associating with a subset of the patient's PHI a level of user clearance required to access the subset of the patient's PHI.

13. The method of claim 1 further comprising operating at least one circle-of-care node, each circle-of-care node including a circle-of-care list for associating at least one user's user identity with the patient's circle-of-care.

14. The method of claim 13 further comprising searching each circle-of-care list of the least one other circle-of-care node to identify any multiple aliases for a user identity, and upon detection of multiple aliases for a user identity, associating the multiple aliases with a patient's circle-of-care.

15. The method of claim 14, further comprising operating the at least one circle-of-care node as a web-based server, and permitting communications with each circle-of-care list from any user system within the healthcare domain.

16. A system for managing access to a patient's protected health information (PHI) within a healthcare domain, comprising:
means for providing a user identity for each user;
means for providing a patient identity for each patient;
means for associating at least one user's user identity with the patient's circle-of-care for each patient's patient identity;
means for determining, for each user request for access to the patient's PHI, access based on whether the user's user identity is associated with the patient's circle-of-care.

17. The system of claim 16 further comprising means for specifying, for each user request for access, a subset of the patient's PHI to which access is requested.

18. The system of claim 16 further comprising means for specifying, for each user request for access, the user's role and a reason for access to the patient's PHI.

19. The system of claim 16 further comprising means for specifying, for each user request for access, a timeframe for access to the patient's PHI.

20. The system of claim 16 further comprising:
means for processing, in response to each user request for access, at least one applicable rule within a rules engine; and
means for outputting an access ruling which is one of a full permission, a partial permission, and a restriction.

21. The system of claim 20, further comprising means for processing at least one applicable rule based on laws and regulations governing the healthcare domain jurisdiction.

22. The system of claim 21, further comprising means for processing at least one applicable rule based on organizational policies and procedures for the healthcare domain.

23. The system of claim 22, further comprising means for processing at least one applicable rule based on clinical context object workgroup (CCOW) standards.

24. The system of claim 20 further comprising means for outputting an explanation for the access ruling based on the at least one applicable rule applied.

25. The system of claim 16 further comprising means for storing the patient's PHI in a relational database and associating with the patient's PHI at least one level of user clearance required to access the patient's PHI.

26. The system of claim 25 further comprising means for associating with each level of user clearance a list of permissions, the list of permissions including at least one of access, update, create, delete and disclose.

27. The system of claim 16 further comprising:
means for storing the patient's PHI in a relational database; and
means for associating with a subset of the patient's PHI a level of user clearance required to access the subset of the patient's PHI.

28. The system of claim 16 further comprising means for operating at least one circle-of-care node, each circle-of-care node including a circle-of-care list for associating at least one user's user identity with the patient's circle-of-care.

29. The system of claim 28 further comprising:
means for searching each circle-of-care list of the least one other circle-of-care node to identify any multiple aliases for a user identity; and
means for associating, upon detection of multiple aliases for a user identity, the multiple aliases with a patient's circle-of-care.

30. The system of claim 29, further comprising:
means for operating the at least one circle-of-care node as a web-based server; and
means for communicating with each circle-of-care list from any user system within the healthcare domain.

31. The system of claim 30, wherein the means for communicating comprises an extensible message format.

32. The system of claim 31, wherein the extensible message format is extensible markup language (XML).

33. The system of claim 16, wherein the means for associating the at least one user's user identity with the patient's circle-of-care comprises a circle-of-care node having data storage components, the data storage components including:
a directory database, the directory database including the user identity for each user;
a relational database, the relational database including patients' PHI;
a rules database, the rules database including applicable access rules; and
a configuration database, the configuration database including information about the circle-of-care node and other circle-of-care nodes.

34. The system of claim 16, wherein the means for associating the at least one user's user identity with the patient's circle-of-care comprises a circle-of-care node having computational components, the computational components including:
a rules engine, the rules engine including at least one applicable rule based on legal requirements, organizational policies, patient restrictions and consents, the role of the user, and accumulated circle-of-care records;
a reporting engine, the reporting engine configured to provide reports on queries received by the circle-of-care node; and
an analysis engine, the analysis engine configured to analyze incoming messages to extract necessary information for associating a user identity to a patient's circle-of-care.

35. The system of claim 16, wherein the means for associating the at least one user's user identity with the patient's circle-of-care comprises a circle-of-care node having communication components, the communication components including:
a security layer, the security layer configured to implement node authentication and encryption;
a network server, the network server for supporting a network communication interface;
a directory query, the directory query configured to query external user directories via the network communication interface, and
a node query, the node query configured to query other circle-of-care nodes via the network communication interface.
